(19) United States
(12) Patent Application Publication
(10) Pub. No.: US 2021/0137348 A1
(43) Pub. Date: May 13, 2021

(54) Washable Floor Mat with Reinforcement Layer

(71) Applicant: Milliken & Company, Spartanburg, SC (US)

(72) Inventors: Kirkland W. Vogt, Simpsonville, SC (US); Padmakumar Puthillath, Greer, SC (US); Daniel T. McBride, Chesnee, SC (US); Mark Holbrook, Ramsbottom (GB)

(73) Assignee: Milliken & Company, Spartanburg, SC (US)

(21) Appl. No.: 17/132,145

(22) Filed: Dec. 23, 2020

Related U.S. Application Data
(62) Division of application No. 15/908,927, filed on Mar. 1, 2018.
(60) Provisional application No. 62/482,728, filed on Apr. 7, 2017.

(51) Int. Cl. A47L 23/26; A47G 27/02; B32B 5/02; B32B 5/24; B32B 25/10; B32B 5/18; D06N 7/00

(52) U.S. Cl. CPC A47L 23/266; A47G 27/025; B32B 5/024; B32B 5/245; D06N 2201/12; B32B 5/18; D06N 7/0068; B32B 2307/208; B32B 25/10

(57) ABSTRACT

This invention relates to a washable floor mat comprising a reinforcement layer. The floor mat includes a textile component and a base component. The textile component contains a reinforcement layer which dramatically reduces and/or eliminates edge deformation that often occurs as a result of the washing process. The textile component and the base component may be joined together to form a single piece floor mat. Alternatively, the textile component and the base component may be releasably attachable to one another by at least one surface attraction means to form a multi-component floor mat. The floor mat is designed to be soiled, washed, and re-used, thereby providing ideal end-use applications in areas such as building entryways.

### CROSS REFERENCE TO RELATED APPLICATION

This application claims priority to and is a divisional of U.S. patent application Ser. No. 15/908,927, entitled “Washable Floor Mat with Reinforcement Layer” which was filed on Mar. 1, 2018, which is a non-provisional of and claims priority to U.S. Provisional Patent Application No. 62/482,728, entitled “Washable Floor Mat with Reinforcement Layer” which was filed on Apr. 7, 2017, both of which are entirely incorporated by reference herein.

### TECHNICAL FIELD

This invention relates to a washable floor mat comprising a reinforcement layer. The floor mat includes a textile component and a base component. The textile component contains a reinforcement layer which dramatically reduces and/or eliminates edge deformation that often occurs as a result of the washing process. The textile component and the base component may be joined together to form a single piece floor mat. Alternatively, the textile component and the base component may be releasably attachable to one another by at least one surface attraction means to form a multi-component floor mat. The floor mat is designed to be soiled, washed, and re-used, thereby providing ideal end-use applications in areas such as building entryways.

### BACKGROUND

High traffic areas, such as entrances to buildings, restrooms, break areas, etc., typically have the highest floorcovering soiling issue. Therefore, floor mats are installed in these areas to collect dirt and liquid that might otherwise cause the appearance of the surrounding area to become less attractive over time. Collection of water by the floor mats also aids in the elimination of slippery floors, which can be a safety hazard.

These entryway floor mats undergo laundering on a regular basis in order to clean the soiled floor mats. Laundering may occur in both residential and commercial/industrial laundering facilities. During the laundering process, the textile component of the floor mat is exposed to physical stretching and/or compressing which results in the problem of permanent deformation of the floor mat. Deformation includes the creation of ripples or waves, which tends to be most visible along the edges of the floor mat.

The present invention provides a solution to the problem of floor mat deformation via the incorporation of a reinforcement layer into the textile component. The reinforcement layer provides additional stability to the floor mat during the laundering process, thereby reducing the amount of physical force acting on the floor mat. The resulting reinforced, laundered floor mat exhibits little to no rippling or waviness, as observed by the human eye. Thus, the reinforced, washable floor mat of the present invention is an improvement over prior art floor mats.

### BRIEF SUMMARY

In one aspect, the invention relates to a floor mat comprising: (a) a textile component comprising a layer of tufted pile carpet formed by tufting face fibers through a reinforcement layer, wherein the reinforcement layer includes: (i) monoaxially drawn tape elements having a rectangular cross-section, an upper surface, and a lower surface, and wherein the tape elements comprise at least a first layer having a draw ratio of at least about 5, a modulus of at least about 2 GPa, a density of at least 0.85 g/cm³, wherein the first layer comprises a polymer selected from the group consisting of polyamide, polyester, and co-polymers thereof, or (ii) monoaxially drawn fibers having at least a first layer, an upper surface and a lower surface, wherein the first layer comprises a polymer and a plurality of voids, wherein the voids are in an amount of between about 3 and 18 percent by volume of the first layer; and (b) a base component.

In another aspect, the invention relates to a multi-component floor mat comprising: A. a textile component comprising (1) a layer of tufted pile carpet formed by tufting face fibers through a reinforcement layer, wherein the reinforcement layer includes either (a) monoaxially drawn tape elements having a rectangular cross-section, an upper surface, and a lower surface, and wherein the tape elements comprise at least a first layer having a draw ratio of at least about 5, a modulus of at least about 2 GPa, a density of at least 0.85 g/cm³, wherein the first layer comprises a polymer selected from the group consisting of polyamide, polyester, and co-polymers thereof or (b) monoaxially drawn fibers having at least a first layer, an upper surface and a lower surface, wherein the first layer comprises a polymer and a plurality of voids, wherein the voids are in an amount of between about 3 and 18 percent by volume of the first layer and (2) at least one surface attachment means; and B. a base component, wherein the base component contains at least one surface attachment means; and wherein the textile component and the base component are releasably attachable to one another via the at least one surface attachment means.

In a further aspect, the invention relates to a multi-component floor mat comprising: A. a textile component comprising (1) a first layer of tufted pile carpet formed by tufting face fibers through a reinforcement layer wherein the reinforcement layer includes either (a) monoaxially drawn tape elements having a rectangular cross-section, an upper surface, and a lower surface, and wherein the tape elements comprise at least a first layer having a draw ratio of at least about 5, a modulus of at least about 2 GPa, a density of at least 0.85 g/cm³, wherein the first layer comprises a polymer selected from the group consisting of polyamide, polyester, and co-polymers thereof or (b) monoaxially drawn fibers having at least a first layer, an upper surface and a lower surface, wherein the first layer comprises a polymer and a plurality of voids, wherein the voids are in an amount of between about 3 and 18 percent by volume of the first layer and (2) a second layer of vulcanized rubber material that contains magnetic particles; and B. a base component comprised of (1) vulcanized rubber that contains magnetic particles or (2) vulcanized rubber having a magnetic coating applied thereto; and wherein the textile component and the base component are releasably attachable to one another via magnetic attraction.

### BRIEF DESCRIPTION OF THE DRAWINGS

FIG. 1 illustrates the rippling effect that occurs as a result of the laundering process in prior art floor mats.

FIG. 2A is an expanded side view of the textile component of the floor mat of the present invention comprising a tufted pile carpet layer with reinforcement layer and a surface attachment means.

FIG. 2B is another expanded side view of the textile component of the floor mat of the present invention comprising a tufted pile carpet layer with reinforcement layer and a surface attachment means.

FIG. 2C is an expanded side view of a floor mat of the present invention comprising a textile component with a reinforcement layer and a base component.

FIG. 2D is an expanded side view of a floor mat of the present invention comprising a textile component with a reinforcement layer and surface attachment means and a base component.

FIG. 2E is a top perspective view of one embodiment of the base component of the floor mat.

FIG. 2F is a top perspective view of one embodiment of the floor mat of the present invention with the textile component partially pulled back from the recessed area of a base component.

FIG. 2G is a top perspective view of another embodiment of the floor mat of the present invention with the textile component and a flat (no recessed area) base component.

FIG. 2H is a top perspective view of the floor mat of FIG. 2G with the textile component partially pulled back from the flat (no recessed area) base component.

FIG. 3 illustrates schematically a reinforcement layer being a woven fabric embedded in a rubber material.

FIG. 4 illustrates schematically an embodiment of the reinforcement layer comprised of a single layer of tape elements.

FIG. 5 illustrates schematically an embodiment of the reinforcement layer comprised of two layers of tape elements.

FIG. 6 illustrates schematically an embodiment of the reinforcement layer comprised of three layers of tape elements.

FIG. 7 illustrates schematically an embodiment of an exemplary tape element having voids and surface crevices.

FIG. 8 is a micrograph at 50,000× magnification of a cross-section of one embodiment of the tape element containing voids.

FIG. 9A is a micrograph at 20,000× magnification of a cross-section of one embodiment of the tape element containing voids and void-initiating particles showing some diameter measurements of the voids.

FIG. 9B is a micrograph at 20,000× magnification of a cross-section of one embodiment of the tape element containing voids and void-initiating particles showing some length measurements of the voids.

FIG. 10 is a micrograph at 1,000× magnification of a surface of one embodiment of the tape element having crevices.

FIG. 11 is a micrograph at 20,000× magnification of a surface of one embodiment of the tape element having crevices.

FIG. 12 is a micrograph at 100,000× magnification of a surface of one embodiment of the tape element having crevices.

FIG. 13 illustrates schematically a reinforcement layer comprised of a woven fabric made from tape elements.

FIG. 14 illustrates schematically the reinforcement layer of FIG. 3 incorporated into the textile component of the floor mat.

### DETAILED DESCRIPTION

The present invention described herein is a washable floor mat with a reinforcement layer. The floor mat is comprised of a textile component and a base component. The textile component of the floor mat contains a reinforcement layer. In one aspect of the invention, the reinforcement layer is comprised of highly drawn, high modulus tape yarns. In a further aspect, the reinforcement layer is comprised of highly drawn, high modulus rectangular tape yarns. The textile component and the base component may be join together to form a single-piece floor mat containing the reinforcement layer. Alternatively, the floor mat may be a multi-component floor mat wherein the textile component and the base component are releasably attached to one another. In one aspect, the textile component and the base component may be releasably attached to one another via magnet attraction.

The base component of the floor mat may be partially or wholly covered with a textile component. Typically, the textile component will be lighter in weight than the base component. Inversely, the base component will weigh more than the textile component.

The textile component and the base component may be releasably attachable to one another via at least one surface attachment means. Surface attachment means include magnetic attraction (such as magnetic coatings, magnetic particles dispersed within a rubber or binder material, spot magnets, and the like), mechanical attachment (such as Velcro® fastening systems, mushroom-shaped protrusions, grommets, and the like), adhesive attraction (such as cohesive materials, silicone materials, and the like), and combinations thereof.

The surface attachment means may be in the form of a coating (such as a magnetic coating), or it may be in the form of discrete attachment mechanisms (such as spot magnets or non-uniform areas of surface attachment means). In one aspect, discrete attachment mechanisms include individual patches of mechanical attachment means. For example, individual patches of Velcro® fastening systems or mushroom-type hook fastening systems may be attached to the textile and base components in a uniform or non-uniform arrangement. For instance, a 1″×1″ Velcro® patch on a 10″×10″ grid may be applied to the textile and base components. Suitable surface attachment means are described, for example, in commonly-owned U.S. Patent Application Publication Nos. 2017/0037567 and 2017/0037568.

In another aspect of the invention, the textile component and the base component may include an edge attachment means. The edge attachment means may be used in combination with the surface attachment means, or it may be used without a surface attachment means (i.e. free from surface attachment means). Edge attachment means include, for example, hook and loop fastening systems (such as Velcro® fasteners), mushroom-type hook fastening systems (such as Dual Lock™ fasteners from 3M), and the like, and combinations thereof.

Referring now to the Figures, FIG. 1 illustrates deformation that occurs as a result of the laundering process. Textile component 100 is shown schematically prior to being subjected to force (such as from exposure to a laundering cycle) and therefore having no deformation. Textile component 100′ is shown schematically after being subjected to force, such as that encountered during a laundering cycle. Textile component 100′ contains ripples 101.

FIG. 2A illustrates textile component 200 comprised of tufted pile carpet 225. Tufted pile carpet 225 is comprised of reinforcement layer 217 and face yarns 215. Reinforcement layer 217 provides stability to face yarns 215 and greatly reduces and/or eliminates the rippling that is often observed along the border and/or edges of the prior art floor mats. The materials comprising face yarns 215 are selected from synthetic fiber, natural fiber, man-made fiber using natural constituents, inorganic fiber, glass fiber, and a blend of any of the foregoing. By way of example only, synthetic fibers may include polyester, acrylic, polyamide, polyolefin, polyaramid, polyurethane, or blends thereof. More specifically, polyester may include polyethylene terephthalate, polytrimethylene terephthalate, polybutylene terephthalate, polylactic acid, or combinations thereof. Polyamide may include nylon 6, nylon 6,6, or combinations thereof. Polyolefin may include polypropylene, polyethylene, or combinations thereof. Polyaramid may include poly-p-phenyleneteraphthalamide (i.e., Kevlar®), poly-m-phenyleneteraphthalamide (i.e., Nomex®), or combinations thereof. Exemplary natural fibers include wool, cotton, linen, ramie, jute, flax, silk, hemp, or blends thereof. Exemplary man-made materials using natural constituents include regenerated cellulose (i.e., rayon), lyocell, or blends thereof.

The material comprising face yarns 215 may be formed from staple fiber, filament fiber, slit film fiber, or combinations thereof. The fiber may be exposed to one or more texturing processes. The fiber may then be spun or otherwise combined into yarns, for example, by ring spinning, open-end spinning, air jet spinning, vortex spinning, or combinations thereof. Accordingly, the material comprising face yarns 215 will generally be comprised of interlaced fibers, interlaced yarns, loops, or combinations thereof.

The material comprising face yarns 215 may be comprised of fibers or yarns of any size, including microdenier fibers or yarns (fibers or yarns having less than one denier per filament). The fibers or yarns may have deniers that range from less than about 0.1 denier per filament to about 2000 denier per filament or, more preferably, from less than about 1 denier per filament to about 500 denier per filament.

Furthermore, the material comprising face yarns 215 may be partially or wholly comprised of multi-component or bi-component fibers or yarns in various configurations such as, for example, islands-in-the-sea, core and sheath, side-by-side, or pie configurations. Depending on the configuration of the bi-component or multi-component fibers or yarns, the fibers or yarns may be splittable along their length by chemical or mechanical action.

Additionally, face yarns 215 may include additives coextruded therein, may be precoated with any number of different materials, including those listed in greater detail below, and/or may be dyed or colored to provide other aesthetic features for the end user with any type of colorant, such as, for example, poly(oxyalkylenated) colorants, as well as pigments, dyes, tints, and the like. Other additives may also be present on and/or within the target fiber or yarn, including antistatic agents, brightening compounds, nucleating agents, antioxidants, UV stabilizers, fillers, permanent press finishes, softeners, lubricants, curing accelerators, and the like.

The face yarns 215 may be dyed or undyed. If the face yarns 215 are dyed, they may be solution dyed. The weight of the face yarn, pile height, and density will vary depending on the desired aesthetics and performance requirements of the end-use for the floor mat. In FIG. 2A, face yarns 215 are illustrated in a loop pile construction. Looking to FIG. 2B, textile component 200 is shown with face yarns 215 in a cut pile construction. Of course, it is to be understood that face yarn constructions including combinations of loop pile and cut pile may likewise be used.

Reinforcement layer 217 may be any suitable fibrous layer such as a knit, woven, non-woven, and unidirectional textile. The reinforcement layer is comprised of material of sufficient strength and integrity to reduce and/or eliminate physical deformation of the floor mat. Reinforcement layer 217 also supports the tufts of face yarns 215.

The tufted pile carpet 225 that includes face yarns tufted into a reinforcement layer may be heat stabilized to prevent dimensional changes from occurring in the finished mat. The heat stabilizing or heat setting process typically involves applying heat to the material that is above the glass transition temperature, but below the melting temperature of the components. The heat allows the polymer components to release internal tensions and allows improvement in the internal structural order of the polymer chains. The heat stabilizing process can be carried out under tension or in a relaxed state. The tufted pile carpet is sometimes also stabilized to allow for the yarn and reinforcement layer to shrink prior to the mat assembly process.

In one aspect of the present invention, the tufted pile carpet is comprised of yarn tufted into the reinforcement layer, which is then injection or fluid dyed, and then bonded with a rubber layer or washable latex backing. The carpet yarn may be selected from nylon 6; nylon 6,6; polyester; and polypropylene fiber. The yarn is tufted into a woven reinforcement layer. The yarn can be of any pile height and weight necessary to support printing. The tufted pile carpet may be printed using any print process. In one aspect, injection dyeing may be utilized to print the tufted pile carpet.

Printing inks will contain at least one dye. Dyes may be selected from acid dyes, direct dyes, reactive dyes, cationic dyes, disperse dyes, and mixtures thereof. Acid dyes include azo, anthraquinone, triphenyl methane and xanthine types. Direct dyes include azo, stilbene, thiazole, dioxsazine and phthalocyanine types. Reactive dyes include azo, anthraquinone and phthalocyanine types. Cationic dyes include thiazole, methane, cyanine, quinolone, xanthene, azine, and triaryl methine. Disperse dyes include azo, anthraquinone, nitrodiphenylamine, naphthal imide, naphthoquinone imide and methane, triarylmethine and quinoline types.

As is known in the textile printing art, specific dye selection depends upon the type of fiber and/or fibers comprising the washable textile component that is being printed. For example, in general, a disperse dye may be used to print polyester fibers. Alternatively, for materials made from cationic dyeable polyester fiber, cationic dyes may be used.

The printing process of the present invention uses a jet dyeing machine, or a digital printing machine, to place printing ink on the surface of the mat in predetermined locations. One suitable and commercially available digital printing machine is the Millitron® digital printing machine, available from Milliken & Company of Spartanburg, S.C. The Millitron® machine uses an array of jets with continuous streams of dye liquor that can be deflected by a controlled air jet. The array of jets, or gun bars, is typically stationary. Another suitable and commercially available digital printing machine is the Chromojet® carpet printing machine, available from Zimmer Machinery Corporation of Spartanburg, S.C. In one aspect, a tufted carpet made according to the processes disclosed in U.S. Pat. Nos. 7,678,159 and 7,846,214, both to Weiner, may be printed with a jet dyeing apparatus as described and exemplified herein.

Viscosity modifiers may be included in the printing ink compositions. Suitable viscosity modifiers that may be utilized include known natural water-soluble polymers such as polysaccharides, such as starch substances derived from corn and wheat, gum arabic, locust bean gum, tragacanth gum, guar gum, guar flour, polygalactomannan gum, xanthan, alginates, and a tamarind seed; protein substances such as gelatin and casein; tannin substances; and lignin substances. Examples of the water-soluble polymer further include synthetic polymers such as known polyvinyl alcohol compounds and polyethylene oxide compounds. Mixtures of the aforementioned viscosity modifiers may also be used. The polymer viscosity is measured at elevated temperatures when the polymer is in the molten state. For example, viscosity may be measured in units of centipoise at elevated temperatures, using a Brookfield Thermosel unit from Brookfield Engineering Laboratories of Middleboro, Mass. Alternatively, polymer viscosity may be measured by using a parallel plate rheometer, such as made by Haake from Rheology Services of Victoria Australia.

After printing, the tufted pile carpet may be vulcanized with a rubber backing. The thickness of the rubber will be such that the height of the finished textile component will be substantially the same height as the surrounding base component when the base component is provided in a tray configuration. Once vulcanized, the textile component may be pre-shrunk by washing.

As also shown in FIGS. 2A and 2B, the textile component 200 may further comprise a magnetic coating layer 210. The magnetic coating layer 210 is present on the surface of the textile component 200 that is opposite face yarns 215. Application of magnetic coating layer 210 to the tufted pile carpet 225 will be described in greater detail below. The resulting textile component 200 is wash durable and exhibits sufficient tuft lock for normal end-use applications. In one alternative embodiment of the invention, the textile component may be a disposable textile component that is removed and disposed of or recycled and then replaced with a new textile component for attachment to the base component.

After the textile component has been made, it will be custom cut to fit into the recessed area of the base component (for instances in which the base component is in the form of a tray) or onto the base component (for instances wherein the base component is substantially flat/trayless/without recessed area). The textile component may be cut using a computer controlled cutting device, such as a Gerber machine. It may also be cut using a mechanical dye cutter, hot knife, straight blade, or rotary blade. In one aspect of the invention, the thickness of the textile component will be substantially the same as the depth of the recessed area when the base component is in the form of a tray.

FIG. 2C illustrates a multi-component floor mat 299 comprised of a textile component 200 and a base component 250. Textile component 200 is comprised of face fibers 215 tufted through a reinforcement layer 217. An optional secondary backing layer 230 comprised of vulcanized rubber may also be included. FIG. 2D illustrates a multi-component floor mat 299 comprised of a textile component 200 and a base component 250. Textile component 200 is comprised of face fibers 215 tufted through a reinforcement layer 217. An optional secondary backing layer 230 comprised of vulcanized rubber may also be included. The textile component 200 further includes a magnetic coating 210. A magnetic coating 210 may also be added to base component 250. Application of magnetic coating layer 210 to the textile and base components will be described in greater detail below. The resulting textile component 200 is wash durable and exhibits sufficient tuft lock for normal end-use applications.

FIG. 2E illustrates one embodiment of the base component of the floor mat of the present invention. Referring to FIG. 2E, base component 250 contains recessed area 260 surrounded by border 270. Border 270 slopes gradually upward from outer perimeter 280 to inner perimeter 290, to create recess 240 within base 250, corresponding to the recessed area of 260. FIG. 2E illustrates that the recessed area 260 of base component 250 possesses a certain amount of depth, thereby defining it as “recessed.” The depth of recessed area 260 is illustrated by 240.

The base component is a planar-shaped tray, which is sized to accommodate the textile component. The base component may also include a border surrounding the tray, whereby the border provides greater dimensional stability to the tray, for example, because the border is thicker, i.e. greater in height relative to the floor. Additionally, the border may be angled upward from its outer perimeter towards the interior of the base component, so as to provide a recessed area where the tray is located, thereby creating a substantially level area between the inner perimeter of the border and the textile component, when the textile component overlays the tray. Additionally, the gradual incline from the outer perimeter of the border to the inner perimeter of the border minimizes tripping hazards and the recess created thereby protects the edges of the textile component.

It can be understood that the base component may be subdivided into two or more recessed trays, by extending a divider from one side of the border to an opposite side of the border, substantially at the height of the inner perimeter. Accordingly, it would be possible to overlay two or more textile components in the recesses created in the base component.

The base component, including the border, may be formed in a single molding process as a unitary article. Alternatively, the border and the tray may be molded separately and then bonded together in a second operation. The tray and border may be made of the same or different materials. Examples of suitable compositions for forming the border and the tray are elastomeric materials (such as natural and synthetic rubber materials and polyurethane materials and mixtures thereof), thermoplastic and thermoset resins and metal. The rubber material may be selected from the group consisting of nitrile rubber, including dense nitrile rubber, foam nitrile rubber, and mixtures thereof; polyvinyl chloride rubber; ethylene propylene diene monomer (EPDM) rubber; vinyl rubber; thermoplastic elastomer; polyurethane elastomer; and mixtures thereof. In one aspect, the base component is typically comprised of at least one rubber material. The rubber material may contain from 0% to 40% of a recycled rubber material.

In one aspect, the base component may be formed into a tray shape according to the following procedure. Rubber strips are placed overlapping the edges of a metal plate. The metal plate is to be placed on top of a sheet rubber and covered on all 4 sides by strip rubber. As the mat is pressed, it will bond the sheet rubber to the strips. This process may be completed, for example, at a temperature of 370° F. and a pressure of 36 psi. However, depending upon the rubber materials selected, the temperature may be in the range from 200° F. to 500° F. and the pressure may be in the range from 10 psi to 50 psi. Using the recommend settings, the mat may be completely cured in 8 minutes. After the rubber strips are bound to the rubber sheet, the metal plate is removed leaving a void (i.e. a recessed area in the base component) in which to place the textile component. The textile component has the ability to be inserted and removed from the base component multiple times.

As seen in FIG. 2F, floor mat 299 is present in an arrangement wherein textile component 200 overlays recessed area 260 of base component 250. A corner of textile component 200 is turned back to further illustrate how the two components fit together within border 270.

As previously discussed herein, the base component of the floor mat may be in the form a tray. However, in one alternative embodiment, the base component of the floor mat may be flat and have no recessed area (i.e. the base component is trayless). A flat base component is manufactured from a sheet of material, such as a rubber material, that has been cut in the desired shape and vulcanized.

FIG. 2G illustrates a multi-component floor mat 299 wherein textile component 200 is combined with base component 250′ that is flat and has no recessed area (i.e. trayless). FIG. 2H shows the multi-component floor mat 299 wherein both textile component 200 and base component 250′ are assembled together.

FIG. 3 illustrates a reinforcement layer 317 containing a fibrous layer 300 embedded into rubber 320. The fibrous layer 300 contains a plurality of fibers 30. The reinforcement layer 317 may be any rubber article reinforced with fibers, and the like. In one embodiment, fibrous layer 300 is a warp knit, weft inserted fabric having weft insertion yarns formed from relatively inextensible reinforcing cords. Alternatively, the fibrous layer 300 may be a woven fabric having weft yarns formed from relatively inextensible reinforcing cords or a laid scrim. Additional suitable fibrous layer constructions having relatively inextensible reinforcing cords in the weft direction of the fabric may be found in US Patent Application Publication No. 2012-0012238.

Fibrous layer 300 is formed from fibers 30. Fibers 30 may have any suitable cross-section such as circular, multi-lobal, square or rectangular (tape), and oval. In one embodiment, the fibers are tape elements. The tape elements may have a rectangular or square cross-sectional shape. These tape elements may also be sometimes referred to as ribbons, strips, tapes, tape fibers, and the like.

One embodiment of the fiber as a tape element is shown in FIG. 4. In this embodiment, tape element 40 contains a first layer 12 having an upper surface 12a and a lower surface 12b. In one embodiment, tape element 40 has a rectangular cross-section. The tape element is considered to have a rectangular or square cross-section even if one or more of the corners of the rectangular/square are slightly rounded or if the opposing sides are not perfectly parallel. Having a rectangular cross-section is preferred for some applications for a variety of reasons. Firstly, the surface available for bonding is greater. Secondly, during a de-bonding event the whole width of the tape is under tension and shear points are significantly reduced or eliminated. In contrast, a multifilament yarn has very little area under tension and there are regions of varying proportions of tension and shear along the circumference of the fiber. In another embodiment, the cross-section of tape element 40 is a square or approximately square. Having a square cross section could also be preferred in some cases where the width is small and the thickness is high, thereby stacking more tapes in a given width thereby increasing the load carrying capacity of the entire reinforcement layer.

In one aspect of the invention, the tape elements have a width in the range from about 0.1 to about 6 mm, more preferably in the range from about 0.2 to about 4 mm, and more preferably in the range from about 0.3 to about 2 mm. In another embodiment, the tape elements have a thickness in the range from about 0.02 to 1 mm, more preferably in the range from about 0.03 to about 0.5 mm, and more preferably in the range from about 0.04 to 0.3 mm. In one embodiment, the tape elements have a width of approximately 1 mm and a thickness of approximately 0.07 mm.

The first layer 12 of the fiber 40 may be any suitable orient-able (meaning that the fiber is able to be oriented) thermoplastic material. Some suitable thermoplastic materials for the first layer include polyamides, co-polyamides, polyesters, co-polyesters, polycarbonates, polyimides, and other orient-able thermoplastic polymers. In one embodiment, the first layer contains polyamide, polyester, and/or co-polymers thereof. In one embodiment, the first layer contains a polyamide or polyamide co-polymer. Polyamides are preferred for some applications as it has high strength, high modulus, high temperature retention of properties, and fatigue performance. In another embodiment, the first layer contains a polyester or polyester co-polymer. Polyesters are preferred for some applications as it has high modulus, low shrink and excellent temperature performance.

In one embodiment, the first layer 12 of tape element 40 is a blend of polyester and nylon 6. The polyester is preferably polyethylene terephthalate. Polyester is employed because of its high modulus and high glass transition temperature which has resulted in the employment of polyester in tire cords and rubber reinforcement cord, primarily due to its flat-spotting resistant nature. Nylon 6 is employed for multiple reasons. It is easier to process than nylon 6, 6. One of the main reasons to incorporate nylon 6 in these embodiments is to function as an adhesion promoter. Nylon 6 has surface groups to which the resorcinol formaldehyde latex can form primary chemical bonds through the resole group. This blend is a physical blend, not a co-polymer and polyester and nylon 6 are immiscible in each other. In one embodiment, powder or pelts of polyester and nylon 6 are simply mixed in the un-melted state to form the blend that will then be feed to an extruder. The extruded tape elements from this physical blend provide good adhesion to rubber and a high modulus.

Also, nylon 6 polymerization results in a certain quantity of unreacted monomer lactam which acts as a co-monomer resulting in the miscibility of polyester and nylon 6. The methylene-ester interactions could enable binary blends to tolerate large differences in methylene content before phase separation could occur. In blends containing large differences in the methylene group (as in this case) entropically driven miscibility could occur if the segmental interaction parameter of the blend is lesser than a critical value. Slight phase separation and crystallization of the phase separation elements cannot be avoided; however, majority of the tape element seems to be homogeneously miscible. Nylon 6,6 is not preferred to be used because of large phase separations at relatively low volume fractions of nylon 6 6 in polyester. This could be due to several reasons. Nylon 6,6 has a higher degree of polymerization as compared to nylon 6. In addition, the crystallization rate of nylon 6,6 is much greater than nylon 6. This is due to the fact that nylon 6,6 (with its symmetrical arrangement) can be incorporated into crystal lattice with much greater ease than nylon 6 chains (which must be packed in anti-parallel chains to favor complete hydrogen bonding).

There is also a unique reason for why the particular process employed is beneficial to extrude and draw the blended polymer. As mentioned above, slight amount of phase separation cannot be avoided. The element may be un-drawable and un-extrudable if the size of the extrudate is too small, as is the case with monofilament and multi-filament spinnerets holes. This is not a problem in this particular process because of its resemblance to a film draw process where the slotted die openings are so wide that they are able to tolerate a small degree of phase separation and crystallization of these phases without yielding completely disconnected regions.

In one embodiment, the blend of polyester and nylon 6 contains from about 50 to about 99% wt polyester and from about 50 to about 1% wt nylon 6. More preferably, the blend of polyester and nylon 6 contains from about 60 to about 95% wt polyester and from about 40 to about 5% wt nylon 6. Most preferably, the blend of polyester and nylon 6 contains from about 70 to about 90% wt polyester and from about 30 to about 10% wt nylon 6. The weight ratios outside the specified ranges would lead to excessive phase separation and crystallization in the extrudate quench tank rendering the element disconnected from the main extrudate. Weight ratios beyond these regions need special compatibilizers such as excess lactam monomers and co-polyesters.

In one aspect of the present invention, the tape elements comprising the reinforcement layer preferably have a draw ratio of at least about 5, a modulus of at least about 2 GPa, and a density of at least about 1.2 g/cm³. In another aspect, the first layer has a draw ratio of at least about 6. In a further aspect, the first layer has a modulus of at least about 3 GPa or at least about 4 GPa. In a further aspect, the first layer has a density of at least about 1.3 g/cm³ and a modulus of about 9 GPa. A first layer having a high modulus is preferred for better performance in reinforcement applications. Lower density for these fibers would be preferred so as to yield a lower weight. Voided fibers would generally tend to have lower densities than their un-voided counterparts.

In one embodiment, the reinforcement layer comprises fiber 40 with a second layer such as shown in FIG. 5. FIG. 5 shows fiber 40 having a first layer with an upper surface 12a and a lower surface 12b, with a second layer 14 on the upper surface 12a of the first layer 12. There may be an additional third layer 16 as shown in FIG. 6 on the lower surface 12b of the first layer 12. While the second layer 14 and third layer 16 are shown on fiber 40 being a rectangular cross-section tape element, the second and/or third layers may be on any shaped fiber. If the second layer 14 and third layer 16 are applied to a fiber without flat sides, the upper half of the circumference would be designated as the “upper” surface and the lower half of the circumference would be designated as the “lower” surface.

The optional second layer 14 and third layer 16 may be formed at the same time as the first layer in a process such as co-extrusion or may be applied after the first layer 12 is formed in a process such as coating. The second and third layers preferably contain a polymer of the same class as the polymer of the first layer, but may also contain additional polymers. In one embodiment, the second and/or third layers contain a polymer a block isocyanate polymer. The second and third layers 14, 16 may help adhesion of the fiber to the rubber. Preferably, the melting temperature (Tm) of the first layer 12 is greater than the Tm of the second layer 14 and third layer 16.

In one embodiment, the fibers 40 (preferably tape elements 40) contain a plurality of voids. FIG. 7 shows a single fiber 40 having a first layer 12 containing a plurality of voids 20. FIG. 8 is a micrograph at 50,000× magnification of a cross-section of one embodiment of the fiber 40 containing voids. “Void” is used herein to mean devoid of added solid and liquid matter, although it is likely the “voids” contain gas. While it has been generally accepted that voided fibers may not have the physical properties needed for use as reinforcement in rubber articles, it has been shown that the voided fibers have some unique benefits. For instance, presence of voids in the fiber occurs at the cost of the polymer mass. This means that the density of these fibers would be lower than their non-void containing counterparts. The volume fraction of the voids would determine the percentage by which the density of this fiber would be lower than the polymer resin. In addition, the voids act as bladders for an adhesive promoter to be infused into the voided layer/voided fiber, thus providing an anchoring effect. Also, the shape of these voids may control the crack propagation front during a stress event, such as fatigue. The extra surface available for crack propagation would reduce the loss of stress singularity in a cyclic fatigue event involving tensile and/or compressive loading. For the thermoplastic polymers making up the first layer 12 of the fiber 40, the high shear flows during the over-drawing layers to chain orientation and elongation leading to the presence of polymer depleted regions or voids. The voids may be present in any or all of the layers 12, 14, 16 of the fibers 40. In addition, reinforcement layer 317 may contain some fibers having no voids and some fibers having voids.

The voids 20 typically have a needle-like shape, meaning that the diameter of the cross-section of the void perpendicular to the fiber length is much smaller than the length of the void due to the monoaxially orientation of the fiber. This shape is due to the monoaxially drawn nature of the fibers 40.

In one embodiment, the voids are present in the fiber in an amount in the range from about 3 to about 20% by volume. In another embodiment, the voids are present in the fiber in an amount in the range from about 3 to about 18% vol, in the range from about 3 to about 15% vol, about 5 to about 18% vol, or about 5 to about 10% vol. The density of the fiber is inversely proportional to the void volume. For example, if the void volume is 10%, then the density is reduced by 10%. Since the increase in the voids is typically observed at higher draw ratios (which results in higher strength), the reduction in density leads to an increase in the specific strength and modulus of the fiber.

In one embodiment, the voids have a diameter in the range of from about 50 to about 400 nm, or more preferably from about 100 to about 200 nm. In another embodiment, the voids have a length in the range from about 1 to about 6 microns, or more preferably from about 2 to about 3 microns.

The voids 20 in the fiber 40 may be formed during the monoaxially orientation process with no additional materials, meaning that the voids do not contain any void-initiating particles. The orientation in a fiber bundle is the driving factor for the origin of voids in the fibers. It is believed that slippages between semi-molten materials lead to the formation of voids. The number density of the voids depends on the viscoelasticity of the polymer element. The uniformity of the voids along the transverse width of the oriented fiber depends on whether the complete polymer element has been oriented in the drawing process along the machine direction. It has been observed that in order for the complete polymer element to be oriented in the drawing process, the heat has to be transferred effectively from the heating element (this could be water, air, infra-red, electric and so on) to the polymer fiber. Conventionally, in industrial processes that utilize a hot air convective heating, one feasible way to orient polymer fibers and still maintain industrial speeds is to restrict the polymer fibers in terms of its width and thickness. This means that complete orientation along the machine direction would be achievable more easily when the polymer fibers are extruded from slotted dies or when the polymer is extruded through film dies and then slit into narrow widths before orientation.

In another embodiment, the fibers 40 contain void-initiating particles. The void-initiating particles may be any suitable particle. The void-initiating particles remain in the finished fiber and the physical properties of the particles are selected in accordance with the desired physical properties of the resultant fiber. When there are void-initiating particles in the first layer 12, the stress to the layer (such as mono-axial orientation) tends to increase or elongate this defect caused by the particle resulting in elongation a void around this defect in the orientation direction. The size of the voids and the ultimate physical properties depend upon the degree and balance of the orientation, temperature and rate of stretching, crystallization kinetics, and the size distribution of the particles. The particles may be inorganic or organic and have any shape such as spherical, platelet, or irregular. In one embodiment, the void-initiating particles are present in an amount in the range from about 2 to about 15% wt of the fiber. In another embodiment, the void-initiating particles are present in an amount in the range from about 5 to about 10% wt of the fiber. In another embodiment, the void-initiating particles are present in an amount in the range from about 5 to about 10% wt of the first layer.

In one preferred embodiment, the void-initiating particle is nanoclay. In one embodiment, the nanoclay is a cloisite with 10% of the clay having a lateral dimension less than 2 μm, 50% less than 6 μm and 90% less than 13 μm. The density of the nanoclay is around 1.98 g/cm³. Nanoclay may be preferred in some applications for a variety of reasons. For instance, nanoclay has a good miscibility with a variety of polymers, polyamides in particular. Also, the high aspect ratio of nanoclay is presumed to improve several mechanical properties due to preferential orientation in the machine direction. In one aspect of the invention, the nanoclay is present in an amount in the range from about 5 to about 10% wt of the fiber. In another aspect, the nanoclay is present in an amount in the range from about 5 to about 10% wt of the first layer. FIG. 9A is a micrograph at 20,000× magnification of a cross-section of one embodiment of the fiber containing voids and void-initiating particles showing some diameter measurements of the voids. FIG. 9B is a micrograph at 20,000× magnification of a cross-section of one embodiment of the fiber containing voids and void-initiating particles showing some length measurements of the voids.

The second and third layers 14, 16 of the fiber 40 may be voided or substantially non-voided. Having non-voided skin layers (second and third layers 14, 16) may help with controlling the size and concentration of the voids throughout the first layer 12 as the skin layers reduce the edge effects of the extrusion process on the inner first layer 12. In one embodiment, the second and/or third layers 14, 16 contain void-initiating particles, voids, and surface crevices while the first layer 12 contains voids but not void-initiating particles.

Referring back to FIG. 7, in another embodiment, the fibers 40 may contain crevices 70 on at least one outermost surface (upper surface 10a or lower surface 10b) of the fiber 40. The fiber 40 upper surface 10a corresponds to the first layer 12 upper surface 12a and the fiber layer 10 lower surface 10b corresponds to the first layer 12 lower surface 12b if the fiber 40 contains only a first layer. The crevices 70 may also be present in the second and/or third layers 14, 16 if present forming the outmost surface of the fibers 40. FIG. 10 is a micrograph at 1,000× magnification of a surface of one embodiment of the fibers having crevices. FIG. 11 is a micrograph at 20,000× magnification of a surface of one embodiment of the fibers having crevices.

The crevices, also known as valleys, channels, or grooves are oriented along the length of the fiber 40 in the direction of monoaxial orientation. The average size of these crevices is in the range from about 300 μm to about 1000 μm in length and are in a frequency in the range from about 5 to about 9 crevices/mm² as shown in FIG. 12, taken at 100,000× magnification. The crevices are formed when there is a defect in the surface of the fiber during the drawing or orientation process. In some embodiments, the nanoclay particle or agglomerated nanoclay particles can act as induced defects. If a nanoclay particle is present in the polymer element, the orientation of the polymer element takes place around the induced crack front and propagates along that front in the machine orientation direction leading to the formation of crevices.

In one embodiment, the crevices are formed by the void-initiating particles. Preferably, the crevices are formed from nanoclay void-initiating particles. While surface defects such as crevices are typically viewed as a defect and are minimized or eliminated in fibers, it has been shown that fibers 40 having crevices 70 display excellent adhesion to rubber when embedded into the rubber when the fibers within the fibrous layers are coated with an adhesion promoter. While not being bound to any particular theory, it is believed that the adhesion promoter at least partially impregnates and fills the crevices forming an anchor and improving the adhesion between the fiber and the rubber. In fact, when tested, the cohesion between the rubber to itself fails before the adhesion between the fiber and the rubber fails.

Referring back to FIG. 3, reinforcement layer 317 containing fiber 30 may be any suitable fibrous layer such as a knit, woven, non-woven, and unidirectional textile. Preferably, reinforcement layer 317 has an open enough construction to allow subsequent coatings (such as rubber) to pass through the reinforcement layer 317 minimizing window pane formation.

In one aspect of the invention, the reinforcement layer is a woven textile substrate. Woven textile substrates include, for example, plain weave, satin weave, twill weave, basket-weave, poplin, jacquard, crepe weave textile substrates, and combinations thereof. Preferably, the woven textile substrate is a plain weave textile substrate. Plain weave textile substrates generally exhibit good abrasion and wear characteristics. Twill weave textile substrates generally exhibit ideal properties for compound curves, which makes these substrates potentially preferred for rubber-containing articles.

In another aspect, the reinforcement layer is a knit textile substrate. Knit textile substrates include, for example, circular knit fabrics, reverse plaited circular knit fabrics, double knit fabrics, single jersey knit fabrics, two-end fleece knit fabrics, three-end fleece knit fabrics, terry knit or double loop knit fabrics, weft inserted warp knit fabrics, warp knit fabrics, warp knit fabrics with or without a micro-denier face, and combinations thereof.

In another embodiment, the reinforcement layer is a multi-axial textile substrate, such as a tri-axial fabric (knit, woven, or non-woven). In another embodiment, the reinforcement layer is a bias fabric. In another embodiment, the reinforcement layer is a non-woven fabric. The term non-woven refers to structures incorporating a mass of yarns that are entangled and/or heat fused so as to provide a coordinated structure with a degree of internal coherency. Non-woven fabrics for use as the reinforcement layer may be formed from processes such as, for example, melt-spun processes, hydro-entangling processes, mechanical entangling processes, stitch-bonding, and the like, and combinations thereof.

In another embodiment, the reinforcement layer is a unidirectional fabric which may have overlapping fiber or may have gaps between the fibers. In one embodiment, a fiber is wrapped continuously around the rubber article to form the unidirectional reinforcement layer. In some embodiments, inducing spacing between the fibers may lead to slight rubber bleeding between the fibers which may be beneficial for adhesion purposes. As shown in FIG. 13, reinforcement layer 1317 is a woven textile substrate with tape elements 1330 having a square cross-sectional area. In this embodiment, the weave is shown as a fairly open weave wherein rubber or other material may enter the spaces between tape elements 1330.

In another embodiment, reinforcement layer 317 may contain fibers and/or yarns that have a different composition, size, and/or shape than fibers 40. These additional fibers may include, but are not limited to: polyamide, aramid (including meta and para forms), rayon, PVA (polyvinyl alcohol), polyester, polyolefin, polyvinyl, nylon (including nylon 6, nylon 6,6, and nylon 4,6), polyethylene naphthalate (PEN), cotton, steel, carbon, fiberglass, steel, polyacrylic, polytrimethylene terephthalate (PTT), polycyclohexane dimethylene terephthalate (PCT), polybutylene terephthalate (PBT), PET modified with polyethylene glycol (PEG), polylactic acid (PLA), polytrimethylene terephthalate, regenerated cellulosics (such as rayon or Tencel), elastomeric materials such as spandex, high-performance fibers such as the polyaramids, polyimides, natural fibers (such as cotton, linen, ramie, and hemp), proteinaceous materials (such as silk, wool, and other animal hairs-such as angora, alpaca, and vicuna), fiber reinforced polymers, thermosetting polymers, and mixtures thereof. These additional fibers/yarns may be used, for example, in the warp direction of a woven reinforcement layer 317, with fibers 40 being used in the weft direction.

In one embodiment, the fibers are surrounded at least partially by an adhesion promoter. A frequent problem in making a rubber composite is maintaining good adhesion between the rubber and the fibers and fibrous layers. A conventional method in promoting the adhesion between the rubber and the fibers is to pretreat the yarns with an adhesion layer typically formed from a mixture of rubber latex and a phenol-formaldehyde condensation product wherein the phenol is almost always resorcinol. This is the so called “RFL” (resorcinol-formaldehyde-latex) method. The resorcinol-formaldehyde latex can contain vinyl pyridine latexes, styrene butadiene latexes, waxes, fillers and/or other additives. “Adhesion layer” used herein includes RFL chemistries and other non-RFL rubber adhesive chemistries.

In one embodiment, the adhesion chemistries are not RFL chemistries. In one embodiment, the adhesion chemistries do not contain formaldehyde. In one embodiment, the adhesion chemistry comprises a non-crosslinked resorcinol-formaldehyde and/or resorcinol-furfural condensate (or a phenol-formaldehyde condensate that is soluble in water), a rubber latex, and an aldehyde component such as 2-furfuraldehyde. The adhesion chemistries may be applied to textile substrates and used for improving the adhesion between the treated textile substrates and rubber materials. More information about these adhesion chemistries may be found in US Patent Application Publication No. 2012/0214372A1.

The adhesion layer may be applied to the fibers before formation into a reinforcement layer or after the reinforcement layer is formed by any conventional method. Preferably, the adhesion layer is a resorcinol formaldehyde latex (RFL) layer or rubber adhesive layer. Generally, the adhesion layer is applied by dipping the reinforcement layer (or fibers comprising the reinforcement layer) in the adhesion layer solution. The coated reinforcement layer (or coated fibers comprising the reinforcement layer) then passes through squeeze rolls and a drier to remove excess liquid. The adhesion layer is typically cured at a temperature in the range of 150° to 200° C.

The adhesion promoter may also be incorporated into a skin layer (the second and/or third layer) of the fiber or may be applied to the fiber and/or reinforcement layer as a freestanding film. Suitable thermoplastic films include, for example, various polyamides and co-polymers thereof, polyolefins and co-polymers thereof, polyurethanes, methymethacrylic acid, and combinations thereof. Commercially available examples of these films include 3M™ 845 film, 3M™ NPE-IATD 0693, and Nolax™ A21.2242 film.

The fibers may be formed in any suitable manner or process. There are two preferred methods for forming the reinforcement layer. The first method begins with slit extruding polymer to form fibers (in one embodiment the fibers are tape elements having a square or rectangular cross-section). The extrusion die typically contains between 5 and 60 slits, each one forming a fiber (tape element). In one embodiment, each slit die has a width of between about 15 mm and 50 mm and a thickness of between about 0.6 and 2.5 mm. The fibers once extruded are typically 4 to 12 mm wide. The fibers may be extruded having one layer or may have a second layer and/or a third layer using co-extrusion.

Next, the fibers are monoaxially drawn. In one embodiment, the fibers are drawn to a ratio of preferably about 5 or greater resulting in a fiber having a modulus of at least about 2 GPa and a density of at least about 0.85 g/cm³.

Once the fibers are formed, a second and/or third layer may be applied to the fibers in any suitable manner, including but not limited to, lamination, coating, printing, and extrusion coating. This may be done before or after the monoaxial orientation step.

In one embodiment, the drawing of the fibers causes voiding to occur in the fiber. In one embodiment, the voids formed are in an amount in the range from about 3 to about 18% vol. In another embodiment, the extrudant contains polymer and void-initiating particles causing voiding in the fiber and/or crevices on the surface of the fiber to form.

The fibers are formed into a reinforcement layer which includes wovens, non-wovens, unidirectionals, and knits. The fibers are then optionally coated with an adhesion promoter such as an RFL coating and at least partially embedded (preferably fully embedded) into rubber. In the embodiments where the fibers contain crevices, it is preferred the adhesion coating at least partially fills the crevices.

In the second method, a polymer is extruded into a film. The film may be extruded having one layer or may have a second layer and/or a third layer using co-extrusion. Next, the film is slit into a plurality of fibers. In one embodiment, the fibers are tape elements having square or rectangular cross-sectional shapes. These fibers are then monoaxially drawn. In one embodiment, the fibers are drawn to a ratio of preferably about 5 or greater resulting in a fiber having a modulus of at least about 2 GPa and a density of at least about 0.85 g/cm3.

Once the fibers are formed, if a second and/or third layer are desired they may be applied to the fibers in any suitable manner, including but not limited to, lamination, coating, printing, and extrusion coating. This may be done before or after the monoaxial orientation step.

In one embodiment, the drawing of the fibers causes voiding to occur in the fiber. In one embodiment, the voids formed are in an amount in the range from about 3 to about 18% vol. In another embodiment, the extrudant contains polymer and void-initiating particles. When monoaxially oriented, this causes voiding in the fiber and/or crevices on the surface of the fiber to form.

The fibers are formed into a fibrous layer which includes wovens, non-wovens, unidirectionals, and knits. The fibers are then optionally coated with an adhesion promoter such as an RFL coating and at least partially embedded into rubber. In the embodiments where the fibers contain crevices, it is preferred the adhesion coating at least partially fills the crevices.

In one embodiment, the die extruding the film or fiber has a rectangular cross-section (having an upper side, a lower side, and 2 edge sides) where at least one of the upper or lower sides of the die has a serrated surface. The may produce films or films having an advantageous surface structure or surface texture.

In another embodiment, the fibers are heat treated before they are formed into the reinforcement layer. Heat treatment of fibers offers several advantages such as higher modulus, higher strength, lower elongation and especially lower shrinkage, when compared to non-heated equivalent fibers. Methods to heat treat the fibers include hot air convective heat treatment, steam heating, infra-red heating or conductive heating such as stretching over hot plates—all under tension.

FIG. 14 illustrates yet another embodiment of the textile component. Textile component 1400 is comprised of tufted pile carpet 1425 and magnetic coating layer 1410. Tufted pile carpet 1425 includes face yarns 1415 tufted through the reinforcement layer 317 shown in FIG. 3, now referred to as reinforcement layer 1417. Herein, reinforcement layer 1417 includes fibers 40 and rubber material 420. In one instance, fibers 40 are provided in a woven arrangement having openings that allow for rubber material 420 to pass through these openings, providing reinforcement layer 1417 having rubber material 420 on both a face yarn side and non-face yarn side of the fibers 40. The rubber material 420 surrounds fibers 40.

Floor mats of the present invention may be of any geometric shape or size as desired for its end-use application. The longitudinal edges of the floor mats may be of the same length and width, thus forming a square shape. Or, the longitudinal edges of the floor mats may have different dimensions such that the width and the length are not the same. Alternatively, the floor mats may be circular, hexagonal, and the like. As one non-limiting example, floor mats of the present invention may be manufactured into any of the current industry standards sizes that include 2 feet by 4 feet, 3 feet by 4 feet, 3 feet by 5 feet, 4 feet by 6 feet, 3 feet by 10 feet, and the like. In one aspect, the textile component and the base component have the same dimensions. In another aspect, the textile component and the base component have different dimensions. For example, the textile component may be smaller is size than the base component. In this example, at least a portion of the base component is visible in a top perspective view of the multi-component floor mat.

As described herein, in one aspect, the textile component and the base component may be held together, at least in part, by magnetic attraction. Magnetic attraction is achieved via application of a magnetic coating to the textile component and/or base component or via incorporation of magnetic particles in a rubber-containing layer prior to vulcanization. Alternatively, magnetic attraction can be achieved using both methods such that a magnetic coating is applied to the textile component and magnetic particles are included in the vulcanized rubber of the base component. The inverse arrangement is also contemplated.

The magnetic coating may be applied to the textile component and/or the base component by several different manufacturing techniques. Exemplary coating techniques include, without limitation, knife coating, pad coating, paint coating, spray application, roll-on-roll methods, troweling methods, extrusion coating, foam coating, pattern coating, print coating, lamination, and mixtures thereof.

In instances wherein magnetic attraction is achieved by incorporating magnetic particles in a rubber-containing layer, the following procedure may be utilized: (a) an unvulcanized rubber-containing material is provided (such as nitrile, SBR, or EPDM rubber), (b) magnetic particles are added to the unvulcanized rubber, (c) the particles are mixed with the rubber, and (d) the mixture of step “c” is formed into a sheet and attached to the bottom of the textile component and/or represents the base component. Mixing in step “c” may be achieved via a rubber mixing mill.

In this application, magnetizable is defined to mean the particles present in the coating or vulcanized rubber layer are permanently magnetized or can be magnetized permanently using external magnets or electromagnets. Once the particles are magnetized, they will keep their magnetic response permanently. The magnetizable behavior for generating permanent magnetism falls broadly under ferromagnets and ferrimagnets. Barium ferrites, strontium ferrites, neodymium and other rare earth metal based alloys are non-limiting examples of materials that can be applied in the magnetic coatings and/or vulcanized rubber layer.

As used herein, magnetically responsive is defined to mean the particles present in the coating and/or vulcanized rubber layer are only magnetically responsive in the presence of external magnets. The component that contains the magnetic particles is exposed to a magnetic field which aligns the dipoles of magnetic particles. Once the magnetic field is removed from the vicinity, the particles will become non-magnetic and the dipoles are no longer aligned. The magnetically responsive behavior or responsive magnetic behavior falls broadly under paramagnets or superparamagnets (particle size less than 50 nm).

This feature of materials being reversibly magnetic occurs when the dipoles of the superparamagnetic or paramagnetic materials are not aligned, but upon exposure to a magnet, the dipoles line up and point in the same direction thereby allowing the materials to exhibit magnetic properties. Non-limiting examples of materials exhibiting these features include iron oxide, steel, iron, nickel, aluminum, or alloys of any of the foregoing.

Further examples of magnetizable magnetic particles include BaFe₃O₄, SrFe₃O₄, NdFeB, AlNiCo, CoSm and other rare earth metal based alloys, and mixtures thereof. Examples of magnetically responsive particles include Fe₂O₃, Fe₃O₄, steel, iron particles, and mixtures thereof. The magnetically receptive particles may be paramagnetic or superparamagnetic. The magnet particles are typically characterized as being non-degradable.

In one aspect of the invention, particle size of the magnetically receptive particles is in the range from 1 micron to 50 microns, or in the range from 1 micron to 40 microns, or in the range from 1 micron to 30 microns, or in the range from 1 micron to 20 microns, or in the range from 1 micron to 10 microns. Particle size of the magnetically receptive particles may be in the range from 10 nm to 50 nm for superparamagnetic materials. Particle size of the magnetically receptive particles is typically greater than 100 nm for paramagnetic and/or ferromagnetic materials.

Magnetic attraction is typically exhibited at any loading of the above magnetic materials. However, the magnetic attraction increases as the loading of magnetic material increases. In one aspect of the invention, the magnetic field strength of the textile component to the base component is greater than 50 Gauss, more preferably greater than 100 Gauss, more preferably greater than 150 Gauss, or even more preferably greater than 200 Gauss.

In one aspect, the magnetic material is present in the coating composition in the range from 25% to 95% by weight of the coating composition. In another aspect, magnetic particle loading may be present in the magnetic coating applied to the textile component in the range from 10% to 70% by weight of the textile component. The magnetic particle loading may be present in the magnetic coating applied to the base component in the range from 10% to 90% by weight of the base component.

The magnetically receptive particles may be present in the vulcanized rubber layer of the textile component in a substantially uniform distribution. In another aspect of the present invention, it is contemplated that the magnetically receptive particles are present in the rubber layer of the textile component in a substantially non-uniform distribution. One example of a non-uniform distribution includes a functionally graded particle distribution wherein the concentration of particles is reduced at the surface of the textile component intended for attachment to the base component. Alternatively, another example of a non-uniform distribution includes a functionally graded particle distribution wherein the concentration of particles is increased at the surface of the textile component intended for attachment to the base component.

The magnetic attraction between the textile component and the base component may be altered by manipulation of the surface area of one or both of the textile and/or base components. The surfaces of one or both of the components may be textured in such a way that surface area of the component is increased. Such manipulation may allow for customization of magnetic attraction that is not directly affected by the amount of magnetic particles present in the floor mat.

For instance, a substantially smooth (less surface area) bottom surface of the textile component will generally result in greater magnetic attraction to the top surface of the base component. In contrast, a less smooth (more surface area) bottom surface of the textile component (e.g. one having ripples or any other textured surface) will generally result in less magnetic attraction to the top surface of the base component. Of course, a reverse arrangement is also contemplated wherein the base component contains a textured surface. Furthermore, both component surfaces may be textured in such a way that magnetic attraction is manipulated to suit the end-use application of the inventive floor mat.

As discussed previously, the magnetic particles may be incorporated into the floor mat of the present invention either by applying a magnetic coating to surface of the textile component or by including the particles in the rubber material of the textile material and/or the base component prior to vulcanization. When incorporation is via a magnetic coating, a binder material is generally included. Thus, the magnetic coating is typically comprised of at least one type of magnetic particles and at least one binder material.

The binder material is typically selected from a thermoplastic elastomer material and/or a thermoplastic vulcanite material. Examples include urethane-containing materials, acrylate-containing materials, silicone-containing materials, and mixtures thereof. Barium ferrites, strontium ferrites, neodymium and other rare earth metal based alloys can be mixed with the appropriate binder to be coated on the textile and/or base component.

In one aspect, the binder material will exhibit at least one of the following properties: (a) a glass transition (T_{g}) temperature of less than 10° C.; (b) a Shore A hardness in the range from 30 to 90; and (c) a softening temperature of greater than 70° C.

In one aspect, an acrylate and/or urethane-containing binder system is combined with Fe₃O₄ to form the magnetic coating of the present invention. The ratio of Fe₃O₄:acrylate and/or urethane binder is in the range from 40-70%:60:30% by weight. The thickness of the magnetic coating may be in the range from 10 mil to 40 mil. Such a magnetic coating exhibits flexibility without any cracking issues.

Following application or inclusion of the magnetic particles into the textile and/or base component, the particles need to be magnetized. Magnetization can occur either during the curing process or after the curing process. Curing is typically needed for the binder material that is selected and/or for the rubber material that may be selected.

During the curing process, the magnetizable particles are mixed with the appropriate binder and applied via a coating technique on the substrate to be magnetized. Once the coating is complete, the particles are magnetized in the presence of external magnets during the curing process. The component that contains the magnetic particles is exposed to a magnetic field which aligns the dipoles of magnetic particles, locking them in place until the binder is cured. The magnetic field is preferably installed in-line as part of the manufacturing process.

However, the magnetic field may exist as a separate entity from the rest of the manufacturing equipment.

Alternatively, the magnetic particles may be magnetized after the curing process. In this instance, the magnetizable particles are added to the binder material and applied to the textile and/or base component in the form of a film or coating. The film or coating is then cured. The cured substrate is then exposed to at least one permanent magnet. Exposure to the permanent magnet may be done via direct contact with the coated substrate or via indirect contact with the coated substrate. Direct contact with the permanent magnet may occur, for example, by rolling the permanent magnet over the coated substrate. The magnet may be rolled over the coated substrate a single time or it may be rolled multiple times (e.g. 10 times). The permanent magnet may be provided in-line with the manufacturing process, or it may exist separately from the manufacturing equipment. Indirect contact may include a situation wherein the coated substrate is brought close to the permanent magnet, but does not contact or touch the magnet.

Depending upon the pole size, strength and domains on the permanent magnet (or electromagnet), it can magnetize the magnetizable coating to a value between 10 and 5000 Gauss or a value close to the maximum Gauss value of the magnetizing medium. Once the coating is magnetized, it will typically remain permanently magnetized.

The washable floor mat of the present invention may be exposed to post treatment steps. For example, chemical treatments such as stain release, stain block, antimicrobial resistance, bleach resistance, and the like, may be added to the washable mat. Mechanical post treatments may include cutting, shearing, and/or napping the surface of the washable multi-component floor mat.

The performance requirements for commercial matting include a mixture of well documented standards and industry known tests. Tuft Bind of Pile Yarn Floor Coverings (ASTM D1335) is performance test referenced by several organizations (e.g. General Services Administration). Achieving tuft bind values greater than 4 pounds is desirable, and greater than 5 pounds even more desirable.

Resistance to Delamination of the Secondary Backing of Pile Yarn Floor Covering (ASTM D3936) is another standard test. Achieving Resistance to Delamination values greater than 2 pounds is desirable, and greater than 2.5 pounds even more desirable.

Pilling and fuzzing resistance for loop pile (ITTS112) is a performance test known to the industry and those practiced in the art. The pilling and fuzzing resistance test is typically a predictor of how quickly the carpet will pill, fuzz and prematurely age over time. The test uses a small roller covered with the hook part of a hook and loop fastener. The hook material is Hook 88 from Velcro of Manchester, N.H. and the roller weight is 2 pounds. The hook-covered wheel is rolled back and forth on the tufted carpet face with no additional pressure. The carpet is graded against a scale of 1 to 5. A rating of 5 represents no change or new carpet appearance. A rating of less than 3 typically represents unacceptable wear performance.

An additional performance/wear test includes the Hexapod drum tester (ASTM D-5252 or ISO/TR 10361 Hexapod Tumbler). This test is meant to simulate repeated foot traffic over time. It has been correlated that a 12,000 cycle count is equivalent to ten years of normal use. The test is rated on a gray scale of 1 to 5, with a rating after 12,000 cycles of 2.5=moderate, 3.0=heavy, and 3.5=severe. Yet another performance/wear test includes the Radiant Panel Test. Some commercial tiles struggle to achieve a Class I rating, as measured by ASTM E 648-06 (average critical radiant flux>0.45=class I highest rating).

The textile component of the floor mat may be washed or laundered in an industrial, commercial or residential washing machine. Achieving 200 commercial washes on the textile component with no structural failure is preferred.

Test Methods

Peel Test: The T-peel test was conducted on an MTS tensile tester at a speed of 12 inch/min. One end of the same (preferably the rubber side) was fixed onto the lower jaw and the fabric was fixed onto the upper jaw. The peel strength of the fabric from the rubber was measured from the average force to separate the layers. A release liner was added on the edge of the sample (a half an inch) between the fibers and the rubber to facilitate the peel test.

The peel strength measured in the above test indicates the force required to separate the single fiber, or unidirectional array of fibers from the rubber. In all the experiments, the array of fibers is pulled at 180 degrees to the rubber sample. In all samples the thickness of the rubber was approximately 3 mm.

### EXAMPLES

The invention will now be described with reference to the following non-limiting examples, in which all parts and percentages are by weight unless otherwise indicated.

### Example 1

Example 1 was a monofilament nylon fiber having a circular cross-sectional shape with a diameter of 240 μm. The nylon used was Nylon 6,6 available from Invista™ as Nylon 6,6 SSP-72. The nylon was extruded out of a slotted die which had 60 slots each slot having a diameter of 1.1 mm. The nylon was extruded at 300° C. at a rate of 20 kg/hour. The resultant fiber was then cooled to 32° C. and monoaxially oriented to a draw ratio of 5. The draw was done in a three stage draw line with a draw of 4, 1.25 and 1 in the first, second and third stages respectively. The finished nylon fiber had a modulus of 1 GPa, a density of 1.14 g/cm³. The fiber contained essentially no voids or crevices on the surface of the fiber.

The monofilament nylon fiber was coated with an RFL formulation utilizing a resorcinol pre-condensate available from Indspec Chemical Corporation, as Penacolite-2170 and a vinyl-pyridine latex available from Omnova Solutions, as Gentac VP 106 at a (coating weight) of 25% by weight of the dry fibers. The coated fibers were then air-dried and cured in an oven at 190° C. for three minutes. The cured fibers were then pressed onto the rubber (available from Akron Rubber Compounding as RA306) in a mold at 300 psi, such that the entire surface of the fiber was embedded into the rubber and the stock was cured at 160° C. for 30 minutes. In order to cover a 0.5 inch (1.27 cm) of rubber, seven fibers were placed 1.7 mm apart forming a unidirectional fibrous layer. A peel test was conducted as described above with the peel strength being 77 lb_{f}/inch. The resultant peeled fibers also had a small amount of rubber still attached. This indicated a slight cohesive failure of rubber (failure of rubber attached to the surface of the nylon fibers from the bulk rubber). This cohesive failure is typical when any open fabric or open fibrous layer gets embedded due to the open structure of the fabric, through which rubber can flow and encapsulate the fabric, and adhere to other rubber.

### Example 2

Example 2 was a multi-filament nylon fiber. To form the multi-filament fiber, two nylon fibers formed from nylon available from Kordsa Global under the trade name T-728 having a circular cross-sectional shape with a denier of 940 were Z twisted together to form a multi-filament nylon fiber having a denier of 1880. The multi-filament twisted fiber had a modulus of 3 GPa and a density of 1.14 g/cm³. The fiber contained essentially no voids or crevices on the surface of the fiber.

The multi-filament nylon fiber was coated with an RFL formulation utilizing a resorcinol pre-condensate available from Indspec Chemical Corporation, as Penacolite-2170 and a vinyl-pyridine latex available from Omnova Solutions, as Gentac VP 106 at a (coating weight) of 25% by weight of the dry fibers. The coated fibers were then air-dried and cured in an oven at 190° C. for 3 minutes. The cured fiber was then embedded into rubber (available from Akron Rubber Compounding as RA306) such that the entire surface of the fiber was embedded into the rubber and the stock was cured at 160° C. for 30 minutes. In order to cover a 0.5 inch (1.27 cm) of rubber, seven fibers were placed at a distance 1.75 mm apart forming a unidirectional fibrous layer. A peel test was conducted as described above with the peel strength being 59 lb_{f}/inch. As in example 1, similar cohesive failure of rubber was observed.

### Example 3

Example 3 was a nylon film (not fiber) having a rectangular cross-sectional shape with a width of 25 mm and a height of 200 μm. The nylon used was nylon 6,6 available from Invista™ as Nylon 6,6 SSP-72. The nylon was extruded out of a film die which was 4″ wide and 1 mm height. The nylon was extruded at 300° C. at a rate of 2 kg/hour. The resultant film was then cooled to 32° C. and not drawn or oriented. The nylon film was brittle and difficult to handle resulting in the film easily cracking. The finished nylon film had a modulus of 500 MPa and a density of 1.14 g/cm³. The film contained essentially no voids or crevices on the surface of the film, but had extremely high surface roughness.

The nylon film was coated with an RFL formulation utilizing a resorcinol pre-condensate available from Indspec Chemical Corporation, as Penacolite-2170 and a vinyl-pyridine latex available from Omnova Solutions, as Gentac VP 106 at a (coating weight) of 25% by weight of the film. The coated film was then air-dried and cured in an oven at 190° C. for three minutes. The cured film was then pressed onto rubber (available from Akron Rubber Compounding as RA306) such that the entire surface of the film was on one side of the rubber and the stock was cured at 160° C. for 30 minutes. A peel test was conducted as described above with the peel strength being 2 lb_{f}/inch. One of the reasons for this low value was because of the inability of the RFL adhesive to bond to the surface of the material and the film to be completely pressed onto the rubber surface (meaning that the surface of the film was not completely embedded in the rubber.

### Example 4

Example 4 was a mono-layer nylon fiber having a rectangular cross-sectional shape with a width of 2 mm and a height of 75 μm. The nylon used was Nylon 6,6 available from Invista™ as Nylon 6,6 SSP-72. The polymer was extruded out of a slotted die which had 12 slots each slot having dimensions of 25 mm by 0.9 mm. The nylon was extruded at 300° C. at a rate of 20 kg/hour. The resultant tape element was then cooled to 32° C. and monoaxially oriented to a draw ratio of between 5 and 6. The draw was done in a three stage draw line with a draw of 4, 1.2, and 1.1 in the first, second and third stages respectively. It is predicted that the same modulus and strength could also be attained if the draw ratios were distributed differently throughout the draw zones. For example a modulus of 6 GPa could also be obtained if the draw ratios were 1.5, 3.3 and 1.1 in the first, second and third stages respectively. The finished nylon tape element had a modulus of 6 GPa, a density of 1.06 g/cm³, and a void volume of 8% vol (by volume) of the fiber. Micrographs of the fiber can be seen in FIG. 9. The voids extended discontinuously throughout the longitudinal section of the fiber. The size of the voids ranged from 50-150 nm in width and 0-5 μm in length. The density of the voids was 8% by volume. The fiber contained essentially no crevices on the surface of the fiber.

The resultant nylon fiber (being a tape element) was then coated with an RFL formulation utilizing a resorcinol pre-condensate available from Indspec Chemical Corporation, as Penacolite-2170 and a vinyl-pyridine latex available from Omnova Solutions, as Gentac VP 106 at a (coating weight) of 25% by weight of the dry tapes. The coated tapes were then air-dried and cured in an oven at 190° C. for 3 minutes. The coated fiber was then laid onto rubber (available from Akron Rubber Compounding as RA306) in a unidirectional pattern having no spaces between the fibers such that the resultant unidirectional fibrous layer covered essentially the whole surface of the rubber. This was cured at 160° C. for 30 minutes. In order to cover a 0.5 inch (1.27 cm) strip of rubber, six rectangular shaped fibers had to be laid. A peel test conducted as described above resulted in rubber breakage at 197 lb_{f}/inch. The peel test force result was the force required to break the rubber in the sample. When the peel test was conducted, the fibers did not pull out of the rubber so the rubber broke. This indicates that the peel strength was at least 197 lb_{f}/inch, but the exact number cannot be determined because of the rubber breakage.

### Example 5

Example 5 was the same as Example 4, except that the total draw ratios for the fibers were 3. The finished nylon fiber had a modulus of 3.5 GPa, a density of 1.06 g/cm³, and a void volume of 8% vol (by volume) of the fiber.

### Example 6

Example 6 was the same as Example 4, except that the total draw ratios for the fibers were 4. The finished nylon fiber had a modulus of 4.1 GPa, a density of 1.06 g/cm³, and a void volume of 8% vol (by volume) of the fiber. Comparing Examples 4, 5, 6, the modulus and strength appear to scale with the draw ratio proportionately.

### Example 7

Example 7 was a monolayer nylon fiber having a rectangular cross-sectional shape with a width of 4 mm and a height of 130 μm. The polymer used was Nylon 6,6 available from Invista™ as Nylon 6,6 SSP-72. The nylon was extruded out of a slotted die which had 12 slots each slot having dimensions of 25 mm by 0.9 mm. The nylon was extruded at 300° C. at a rate of 60 kg/hour. The resultant tape element was then cooled to 32° C. and monoaxially oriented to a draw ratio of between 5 and 6. The draw was done in a three stage draw line with a draw of 3.1, 1.65 and 1.1 in the first, second and third stages respectively. The finished nylon tape element had a modulus of 800 MPa, a density of 1.14 g/cm³. The fiber contained essentially no voids or crevices on the surface of the fiber. Comparing the fibers of Example 7 to Example 4, the fibers of Example 7 were twice as wide, almost twice as thick and were extruded in the same size slot die but at three times the output. As mentioned previously, the orientation in a fiber bundle is the driving factor for the origin of voids in the fibers. The presence and uniformity of the voids along the transverse width of the oriented fiber depends on whether the complete polymer element has been oriented in the drawing process along the machine direction. The lack of voids is due to the fact that effective heat transfer has not occurred in the polymer element to orient it completely. Regions of oriented and un-oriented sections were obtained in the polymer tapes.

The nylon fiber was coated with an RFL formulation utilizing a resorcinol pre-condensate available from Indspec Chemical Corporation, as Penacolite-2170 and a vinyl-pyridine latex available from Omnova Solutions, as Gentac VP 106 at a (coating weight) of 25% by weight of the dry tapes. The coated fiber was then laid onto rubber (available from Akron Rubber Compounding as RA306 in a unidirectional pattern having no spaces between the fibers such that the resultant unidirectional fibrous layer covered essentially the whole surface of the rubber. This was cured at 160° C. for 30 minutes. In order to cover a 0.5 inch (1.27 cm) strip of rubber, six rectangular shaped fibers had to be laid.

### Example 8

The coated fibers of Example 4 were laid onto rubber (available from Akron Rubber Compounding as RA306) in a unidirectional pattern having 0.5 mm spaces between the fibers forming a unidirectional fibrous layer that did not cover the whole surface of the rubber. This was cured at 160° C. for 30 minutes. For a 0.5 inch (1.27 cm) strip of rubber, six rectangular shaped fibers were laid. A release film was placed between the fiber layer and the rubber on one edge for ease of the peel test. A peel test conducted as described above resulted in rubber breakage at 180 lb_{f}/inch indicating that the peel strength was greater than this value. This value was almost equal to the peel strength of the unidirectional fibrous layer without spaces between the fibers (Example 4). The slight variation in the values is unavoidable since this force is indicative of the breaking strength of rubber and hence depends on the rubber thickness.

### Example 9

The nylon film of Example 3 was adhesively bonded to rubber (available from Akron Rubber Compounding as RA306) utilizing an adhesive film available from 3M as 3M 845 film. The adhesive film was composed of an acrylic copolymer, a tackifier and vinyl carboxylic acid. The film was pressed into the rubber (with the adhesive film between the rubber and the nylon film), such that the entire surface of the nylon film was not covered (not embedded) by rubber and then sample was cured at 160° C. for 30 minutes. A peel test was conducted as described above with the peel strength being 27 lb_{f}/inch which is an increase in peel strength as compared to Example 3 using an RFL coating adhesive.

### Example 10

The fibers of Example 10 were similar to the fiber of Example 4, with the addition of void-initiating particles. Example 10 was a monolayer nylon fiber having a rectangular cross-sectional shape with a width of 2 mm and a height of 75 μm. The polymer used was Nylon 6,6 available from Invista™ as Nylon 6,6 SSP-72 and contained 7% by wt. of nanoclay (cloisite) available from Southern Clay Company. The nylon was extruded out of a slotted die which had 12 slots each slot having dimensions of 25 mm by 0.9 mm. The nylon was extruded at 300° C. at a rate of 20 kg/hour. The resultant fiber (being a tape element) was then cooled to 32° C. and monoaxially oriented to a draw ratio of between 5 and 6. The draw was done in a three stage draw line with a draw of 4, 1.2 and 1.1 in the first, second and third stages respectively. As mentioned in Example 1, the same modulus and strength could also be attained if the draw ratios were distributed differently throughout the draw zones. The finished nylon fiber had a modulus of 6 GPa, a density of 1.06 g/cm³, and a void volume of 8% vol of the fiber. The voids of in the fiber can be seen in the micrographs of FIGS. 10a and 10b. The voids extended discontinuously throughout the longitudinal section of the fiber. The size of the voids ranged from 50-150 nm in width and 0-5 μm in length. The concentration of the voids was 8% by volume. The voids were similar in shape to the ones obtained without void initiating particles. The fiber also contained crevices on the surface of the fiber. These crevices present on the face of the fiber were discontinuous along the longitudinal direction of the fibers and their length ranged between about 300 μm to 1000 μm. The crevices on the surface of the fiber can be seen in the micrographs of FIGS. 11, 12, and 13.

The nylon fiber was coated with an RFL formulation utilizing a resorcinol pre-condensate available from Indspec Chemical Corporation, as Penacolite-2170 and a vinyl-pyridine latex available from Omnova Solutions, as Gentac VP 106 at a (coating weight) of 25% by weight of the dry tapes. The coated fibers were then air-dried and cured in an oven at 190° C. for 3 minutes. The coated fiber was then laid onto rubber (available from Akron Rubber Compounding as RA306) in a unidirectional pattern having no spaces between the fibers such that the resultant unidirectional fibrous layer covered essentially the whole surface of the rubber. This was cured at 160° C. for 30 minutes. In order to cover a 0.5 inch (1.27 cm) strip of rubber, six rectangular shaped fibers had to be laid. A release film was placed between the fiber layer and the rubber on one edge for ease of the peel test. A peel test conducted as described above resulted in rubber breakage at 197 lb_{f}/inch indicating that the peel strength was greater than this value.

### Example 11

Example 11 was a polyester fiber having a rectangular cross-sectional shape with a width of 2 mm and a height of 60 μm. The polyester used was polyethylene terephthalate available from Nanya Plastics Corporation as PET IV 60. The polyester was extruded out of a slotted die which had 12 slots each slot having dimensions of 25 mm by 0.9 mm. The polyester was extruded at 300° C. at a rate of 20 kg/hour. The resultant fiber was then cooled to 32° C. and monoaxially oriented to a draw ratio of 7-9. The draw was done in a three stage draw line with a draw of 3.4, 2.2 and 1 in the first, second and third stages respectively. The finished polyester tape element had a modulus of 8 GPa, a density of 1.20 g/cm³, and a void volume of 8% vol of the fiber. The fiber contained essentially no crevices on its surface.

The polyester fiber was coated by a two stage dip procedure using a pre-dip solution containing a caprolactam blocked iso-cyanate available from EMS as Grilbond IL-6 and curing at 225 C for three minutes, followed by dipping in a standard RFL formulation utilizing a resorcinol pre-condensate available from Indspec Chemical Corporation, as Penacolite-2170 and a vinyl-pyridine latex available from Omnova Solutions, as Gentac VP 106 at a (coating weight) of 25% by weight of the dry tapes. The coated fibers were then air-dried and cured in an oven at 190° C. for three minutes. The coated fiber was then laid onto rubber (available from Akron Rubber Compounding as RA306) in a unidirectional pattern having no spaces between the fibers such that the resultant unidirectional fibrous layer covered essentially the whole surface of the rubber. This was cured at 160° C. for 30 minutes. In order to cover a 0.5 inch (1.27 cm) strip of rubber, six rectangular shaped fibers had to be laid. When the peel test was conducted, the pulled out fibers had a large chunk of rubber still attached. The peel test resulted in adhesion strength of 120 lb_{f}/inch showing the cohesive failure of rubber.

### Example 12

Example 12 was a mono-layer fiber blend of polyester and nylon 6 6 having a rectangular cross-sectional shape with a width of 1.5 mm and a height of 100 μm. The polyester used was polyethylene terephthalate available from Nanya Plastics Corporation as PET IV 60; the nylon used was Nylon 6,6 available from Invista™ as Nylon 6,6 SSP-72. The polymer was extruded out of a slotted die which had 12 slots each slot having dimensions of 25 mm by 0.9 mm. The blend was physically mixed in a 90:10 ratio (90% polyester and 10% nylon by weight) and was extruded at 300° C. at a rate of 20 kg/hour. The resultant tape element was then cooled to 32° C. and monoaxially oriented to a draw ratio of between 5 and 7. The draw was done in a three stage draw line with a draw of 3, 2, and 0.9 in the first, second and third stages respectively. It has to be noted that a slight overfeeding is required in the last stage for various reasons. The overfeeding reduces shrinkage and modulus relaxation (creep) of the fibers. It also increases toughness of the fibers. It is predicted that the same modulus and strength could also be attained if the draw ratios were distributed differently throughout the draw zones. For example a modulus of 10 GPa could also be obtained if the draw ratios were 1.5, 3.3 and 0.9 in the first, second and third stages respectively. The finished polyester-nylon blended tape element had a modulus of 10 GPa, and a density of 1.37 g/cm³.

The polyester-nylon blend fiber was coated by a two stage dip procedure using a pre-dip solution containing a caprolactam blocked iso-cyanate available from EMS as Grilbond IL-6 and curing at 225 C for three minutes, followed by dipping in a standard RFL formulation utilizing a resorcinol pre-condensate available from Indspec Chemical Corporation, as Penacolite-2170 and a vinyl-pyridine latex available from Omnova Solutions, as Gentac VP 106 at a (coating weight) of 25% by weight of the dry tapes. The coated tapes were then air-dried and cured in an oven at 190° C. for 3 minutes. The coated fiber was then laid onto rubber (available from Akron Rubber Compounding as RA306) in a unidirectional pattern having no spaces between the fibers such that the resultant unidirectional fibrous layer covered essentially the whole surface of the rubber. This was cured at 160° C. for 30 minutes. In order to cover a 0.5 inch (1.27 cm) strip of rubber, six rectangular shaped fibers had to be laid. A peel test conducted as described above yielded a value of 143 lb_{f}/inch.

### Example 13

Example 13 was a mono-layer fiber blend of polyester and nylon 6 6 having a rectangular cross-sectional shape with a width of 1.5 mm and a height of 100 μm. The polyester used was polyethylene terephthalate available from Nanya Plastics Corporation as PET IV 60; the nylon used was Nylon 6,6 available from Invista™ as Nylon 6,6 SSP-72. The polymer was extruded out of a slotted die which had 12 slots each slot having dimensions of 25 mm by 0.9 mm. The blend was physically mixed in a 70:30 ratio (70% polyester and 30% nylon by weight) and was extruded at 300° C. at a rate of 20 kg/hour. The resultant tape element was then cooled to 32° C. and monoaxially oriented to a draw ratio of between 5 and 7. The draw was done in a three stage draw line with a draw of 3, 2, and 0.9, in the first, second and third stages respectively. It has to be noted that a slight overfeeding is required in the last stage for various reasons. The overfeeding reduces shrinkage and modulus relaxation (creep) of the fibers. It also increases toughness of the fibers. It is predicted that the same modulus and strength could also be attained if the draw ratios were distributed differently throughout the draw zones. For example a modulus of 10 GPa could also be obtained if the draw ratios were 1.5, 3.3 and 0.9 in the first, second and third stages respectively. The finished polyester-nylon blended tape element had a modulus of 10 GPa, and a density of 1.37 g/cm³.

The polyester-nylon blend fiber was coated by a two stage dip procedure using a pre-dip solution containing a caprolactam blocked iso-cyanate available from EMS as Grilbond IL-6 and curing at 225 C for three minutes, followed by dipping in a standard RFL formulation utilizing a resorcinol pre-condensate available from Indspec Chemical Corporation, as Penacolite-2170 and a vinyl-pyridine latex available from Omnova Solutions, as Gentac VP 106 at a (coating weight) of 25% by weight of the dry tapes. The coated tapes were then air-dried and cured in an oven at 190° C. for 3 minutes. The coated fiber was then laid onto rubber (available from Akron Rubber Compounding as RA306) in a unidirectional pattern having no spaces between the fibers such that the resultant unidirectional fibrous layer covered essentially the whole surface of the rubber. This was cured at 160° C. for 30 minutes. In order to cover a 0.5 inch (1.27 cm) strip of rubber, six rectangular shaped fibers had to be laid. A peel test conducted as described above resulted in a value of 143 lb_{f}/inch.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

We claim:

1. A multi-component floor mat comprising:
A. A textile component comprising (1) a layer of tufted pile carpet formed by tufting face fibers through a reinforcement layer, wherein the reinforcement layer includes either (a) monoaxially drawn tape elements having a rectangular cross-section, an upper surface, and a lower surface, and wherein the tape elements comprise at least a first layer having a draw ratio of at least about 5, a modulus of at least about 2 GPa, a density of at least 0.85 g/cm³, wherein the first layer comprises a polymer selected from the group consisting of polyamide, polyester, and co-polymers thereof or (b) monoaxially drawn fibers having at least a first layer, an upper surface and a lower surface, wherein the first layer comprises a polymer and a plurality of voids, wherein the voids are in an amount of between about 3 and 18 percent by volume of the first layer and (2) at least one surface attachment means; and
B. A base component, wherein the base component contains at least one surface attachment means; and
wherein the textile component and the base component are releasably attachable to one another via the at least one surface attachment means.

2. The multi-component floor mat of claim 1, wherein the at least one surface attachment means is selected from magnetic attraction, mechanical attachment, adhesive attraction, and combinations thereof.

3. The multi-component floor mat of claim 2, wherein the textile component is magnetically receptive.

4. The multi-component floor mat of claim 2, wherein the base component is permanently magnetized.

5. The multi-component floor mat of claim 1, wherein the textile component of the floor mat can withstand at least one wash cycle in a commercial or residential washing machine whereby the textile component is suitable for re-use after exposure to the at least one wash cycle.

6. The multi-component floor mat of claim 1, wherein the face fibers are selected from the group consisting of synthetic fiber, natural fiber, man-made fiber using natural constituents, inorganic fiber, glass fiber, and mixtures thereof

7. The multi-component floor mat of claim 1, wherein the face fibers are selected from nylon 6; nylon 6,6; polyester; polypropylene; or combinations thereof.

8. The multi-component floor mat of claim 1, wherein the face fibers comprise cut pile, loop pile, or combinations thereof.

9. The multi-component floor mat of claim 1, wherein the face fibers are dyed, undyed, printed, or combinations thereof.

10. The multi-component floor mat of claim 1, wherein the reinforcement layer is selected from the group consisting of woven material, nonwoven material, knitted material, and combinations thereof.

11. The multi-component floor mat of claim 1, wherein the base component is selected from the group consisting of elastomeric materials, thermoplastic resins, thermoset resins and metal.

12. The multi-component floor mat of claim 11, wherein elastomeric materials are selected from the group consisting of natural rubber materials, synthetic rubber materials, polyurethane materials, and mixtures thereof.

13. The multi-component floor mat of claim 12, wherein the rubber material is selected from the group consisting of nitrile rubber, polyvinyl chloride rubber, ethylene propylene diene monomer (EPDM) rubber, vinyl rubber, thermoplastic elastomer, and mixtures thereof.

14. The multi-component floor mat of claim 12, wherein the rubber material contains 0% to 40% recycled rubber material.

15. The multi-component floor mat of claim 1, wherein the textile component further includes a nonwoven layer sandwiched between the reinforcement layer and the base component.

16. The multi-component floor mat of claim 1, wherein the textile component and the base component further contain at least one edge attachment means.

17. The multi-component floor mat of claim 16, wherein the at least one edge attachment means is selected from the group consisting of hook and loop fastening systems, mushroom-type hook fastening systems, and combinations thereof.

18. The multi-component floor mat of claim 16, wherein the at least one edge attachment means of the textile component is narrower in width than the edge attachment means of the base component.

19. A multi-component floor mat comprising:
A. A textile component comprising (1) a first layer of tufted pile carpet formed by tufting face fibers through a reinforcement layer wherein the reinforcement layer includes either (a) monoaxially drawn tape elements having a rectangular cross-section, an upper surface, and a lower surface, and wherein the tape elements comprise at least a first layer having a draw ratio of at least about 5, a modulus of at least about 2 GPa, a density of at least 0.85 g/cm³, wherein the first layer comprises a polymer selected from the group consisting of polyamide, polyester, and co-polymers thereof or (b) monoaxially drawn fibers having at least a first layer, an upper surface and a lower surface, wherein the first layer comprises a polymer and a plurality of voids, wherein the voids are in an amount of between about 3 and 18 percent by volume of the first layer and (2) a second layer of vulcanized rubber material that contains magnetic particles; and
B. A base component comprised of (1) vulcanized rubber that contains magnetic particles or (2) vulcanized rubber having a magnetic coating applied thereto; and
wherein the textile component and the base component are releasably attachable to one another via magnetic attraction.

20. The multi-component floor mat of claim 19, wherein the textile component is magnetically receptive.

21. The multi-component floor mat of claim 19, wherein the base component is permanently magnetized.

22. The multi-component floor mat of claim 19, wherein the textile component of the floor mat can withstand at least one wash cycle in a commercial or residential washing machine whereby the textile component is suitable for re-use after exposure to the at least one wash cycle.

23. The multi-component floor mat of claim 19, wherein the face fibers are selected from the group consisting of synthetic fiber, natural fiber, man-made fiber using natural constituents, inorganic fiber, glass fiber, and mixtures thereof

24. The multi-component floor mat of claim 19, wherein the face fibers are selected from nylon 6; nylon 6,6; polyester; polypropylene; or combinations thereof.

25. The multi-component floor mat of claim 19, wherein the face fibers comprise cut pile, loop pile, or combinations thereof.

26. The multi-component floor mat of claim 19, wherein the face fibers are dyed, undyed, printed, or combinations thereof.

27. The multi-component floor mat of claim 19, wherein the reinforcement layer is selected from the group consisting of woven material, nonwoven material, knitted material, and combinations thereof.

28. The multi-component floor mat of claim 19, wherein the vulcanized rubber is selected from the group consisting of nitrile rubber, polyvinyl chloride rubber, ethylene propylene diene monomer (EPDM) rubber, vinyl rubber, thermoplastic elastomer, and mixtures thereof.

29. The multi-component floor mat of claim 19, wherein the magnet particles are non-degradable.

30. The multi-component floor mat of claim 19, wherein the magnetic particles are in an oxidized state.

31. The multi-component floor mat of claim 19, wherein the magnetic particles are in the size range of from 1 micron to 50 microns.

32. The multi-component floor mat of claim 19, wherein the magnetic particles are magnetizable magnetic particles selected from the group consisting of Fe₃O₄, SrFe₃O₄, NdFeB, AlNiCo, CoSm and other rare earth metal based alloys, and mixtures thereof.

33. The multi-component floor mat of claim 19, wherein the magnetic particles are magnetically receptive particles selected from the group consisting of Fe₂O₃, Fe₃O₄, steel, iron particles, and mixtures thereof.

34. The multi-component floor mat of claim 19, wherein the magnetically receptive particles are paramagnetic or superparamagnetic.

35. The multi-component floor mat of claim 19, wherein the magnetic particle loading is in the range from 10% to 70% by weight in the textile component.

36. The multi-component floor mat of claim 19, wherein the magnetic particle loading is in the range from 10% to 90% by weight in the base component.

37. The multi-component floor mat of claim 19, wherein at least one of the textile and base components is characterized as having a functionally graded magnetic particle distribution.

38. The multi-component floor mat of claim 19, wherein the magnetic particles are ferrite.

39. The multi-component floor mat of claim 19, wherein the strength of magnetic attraction is greater than 50 Gauss.

40. The multi-component floor mat of claim 19, wherein the vulcanized rubber contains 0% to 40% recycled rubber material.

41. The multi-component floor mat of claim 19, wherein the textile component and the base component further contain at least one edge attachment means.

42. The multi-component floor mat of claim 41, wherein the at least one edge attachment means is selected from the group consisting of hook and loop fastening systems, mushroom-type hook fastening systems, and combinations thereof.

43. The multi-component floor mat of claim 41, wherein the at least one edge attachment means of the textile component is narrower in width than the edge attachment means of the base component.
